(19) United States
(12) Patent Application Publication
(10) Pub. No.: US 2026/0143486 A1
(43) Pub. Date: May 21, 2026

(54) COMMUNICATION CONFIGURATION ADAPTATION

(71) Applicant: QUALCOMM Incorporated, San Diego, CA (US)

(72) Inventors: Gabi SARKIS, San Diego, CA (US); Diana MAAMARI, San Diego, CA (US); Jae Ho RYU, San Diego, CA (US)

(21) Appl. No.: 18/952,975

(22) Filed: Nov. 19, 2024

(51) Int. Cl. H04W 72/1263; H04W 72/23; H04W 76/38

(52) U.S. Cl. CPC H04W 72/1263; H04W 72/23; H04W 76/38

(57) ABSTRACT

Methods, systems, and devices for wireless communications are described. A user equipment (UE) may switch between operation in accordance with a first communication configuration (e.g., a first maximum bandwidth, a first minimum processing timeline, a first minimum scheduling offset, and/or a first maximum rank) to operation in accordance with a second, limited, communication configuration (e.g., a second smaller bandwidth, a second longer minimum processing timeline, a second longer minimum scheduling offset, and/or a second smaller maximum rank) based on a scheduling offset threshold. The UE may use the first communication configuration for communications that are scheduled in accordance with a scheduling offset equal to or greater than the scheduling offset threshold, and the UE may use the second communication configuration for communications that are scheduled in accordance with a scheduling offset less than the scheduling offset threshold.

### FIELD OF TECHNOLOGY

The following relates to wireless communications, including communication configuration adaptation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control information that indicates a first communication configuration and a second communication configuration, where the first communication configuration is associated with at least one of a first maximum bandwidth, a first minimum processing timeline, a first minimum scheduling offset, or a first maximum rank, where the second communication configuration is associated with at least one of a second maximum bandwidth, a second minimum processing timeline, a second minimum scheduling offset, or a second maximum rank, and where one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank, receiving a control message that includes scheduling information for a communication, where the scheduling information indicates a scheduling offset associated with the communication, and performing the communication in accordance with one of the first communication configuration or the second communication configuration based on comparison of the scheduling offset to a scheduling offset threshold associated with the second communication configuration.

A UE for wireless communications is described. The UE may include one or more memories storing processor executable code, and one or more processors coupled with the one or more memories. The one or more processors may individually or collectively be operable to execute the code to cause the UE to receive control information that indicates a first communication configuration and a second communication configuration, where the first communication configuration is associated with at least one of a first maximum bandwidth, a first minimum processing timeline, a first minimum scheduling offset, or a first maximum rank, where the second communication configuration is associated with at least one of a second maximum bandwidth, a second minimum processing timeline, a second minimum scheduling offset, or a second maximum rank, and where one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank, receive a control message that includes scheduling information for a communication, where the scheduling information indicates a scheduling offset associated with the communication, and perform the communication in accordance with one of the first communication configuration or the second communication configuration based on comparison of the scheduling offset to a scheduling offset threshold associated with the second communication configuration.

Another UE for wireless communications is described. The UE may include means for receiving control information that indicates a first communication configuration and a second communication configuration, where the first communication configuration is associated with at least one of a first maximum bandwidth, a first minimum processing timeline, a first minimum scheduling offset, or a first maximum rank, where the second communication configuration is associated with at least one of a second maximum bandwidth, a second minimum processing timeline, a second minimum scheduling offset, or a second maximum rank, and where one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank, means for receiving a control message that includes scheduling information for a communication, where the scheduling information indicates a scheduling offset associated with the communication, and means for performing the communication in accordance with one of the first communication configuration or the second communication configuration based on comparison of the scheduling offset to a scheduling offset threshold associated with the second communication configuration.

A non-transitory computer-readable medium storing code for wireless communications is described. The code may include instructions executable by one or more processors to receive control information that indicates a first communication configuration and a second communication configuration, where the first communication configuration is associated with at least one of a first maximum bandwidth, a first minimum processing timeline, a first minimum scheduling offset, or a first maximum rank, where the second communication configuration is associated with at least one of a second maximum bandwidth, a second minimum processing timeline, a second minimum scheduling offset, or a second maximum rank, and where one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank, receive a control message that includes scheduling information for a communication, where the scheduling information indicates a scheduling offset associated with the communication, and perform the communication in accordance with one of the first communication configuration or the second communication configuration based on comparison of the scheduling offset to a scheduling offset threshold associated with the second communication configuration.

Some examples of the method, UEs, and non-transitory computer-readable medium described herein may further include operations, features, means, or instructions for performing a transition from operation in accordance with the first communication configuration to operation in accordance with the second communication configuration based on the scheduling offset being greater than the scheduling offset threshold, and where performing the communication includes performing the communication in accordance with the second communication configuration based on the transition.

Some examples of the method, UEs, and non-transitory computer-readable medium described herein may further include operations, features, means, or instructions for monitoring, after the transition and while operating in accordance with the second communication configuration, one or more first physical downlink control channel (PDCCH) candidates associated with the second communication configuration and refraining from monitoring, after the transition and while operating in accordance with the second communication configuration, one or more second PDCCH candidates associated with the first communication configuration.

In some examples of the method, UEs, and non-transitory computer-readable medium described herein, the control message includes a field that may have a value that indicates to operate in accordance with the second communication configuration and the transition may be based on the field.

Some examples of the method, UEs, and non-transitory computer-readable medium described herein may further include operations, features, means, or instructions for receiving a second control message that includes the field, where the field may have a second value that indicates to operate in accordance with the first communication configuration, performing a second transition from operation in accordance with the first communication configuration to operation in accordance with the second communication configuration based on the second control message, and performing, after the second transition, a second communication in accordance with the first communication configuration.

Some examples of the method, UEs, and non-transitory computer-readable medium described herein may further include operations, features, means, or instructions for receiving, after reception of the control message, a second control message that includes second scheduling information for a second communication, where the second scheduling information indicates a second scheduling offset associated with the communication, performing a second transition, based on the second scheduling offset being greater than or equal to the scheduling offset threshold, from operation in accordance with the second communication configuration to operation in accordance with the first communication configuration, and performing, based on the second transition, the second communication in accordance with the first communication configuration.

Some examples of the method, UEs, and non-transitory computer-readable medium described herein may further include operations, features, means, or instructions for receiving, after reception of the control message, a second control message that includes second scheduling information for a second communication, where the second scheduling information indicates a second scheduling offset associated with the communication and refraining from performing the second communication based on the second scheduling offset being less than the scheduling offset threshold and based on operating in accordance with the second communication configuration.

Some examples of the method, UEs, and non-transitory computer-readable medium described herein may further include operations, features, means, or instructions for transmitting a feedback message that indicates that the UE refrained from performance of the second communication.

Some examples of the method, UEs, and non-transitory computer-readable medium described herein may further include operations, features, means, or instructions for receiving, after reception of the control message, a second control message that includes second scheduling information for a second communication, where the second scheduling information indicates at least one of a rank that exceeds the second maximum rank or a bandwidth that exceeds the second maximum bandwidth, performing a second transition, based on the rank exceeding the second maximum rank or the bandwidth exceeding the second maximum bandwidth, from operation in accordance with the second communication configuration to operation in accordance with the first communication configuration, and performing, based on the second transition, the second communication in accordance with the first communication configuration.

Some examples of the method, UEs, and non-transitory computer-readable medium described herein may further include operations, features, means, or instructions for receiving, after reception of the control message, a second control message that includes second scheduling information for a second communication, where the second scheduling information indicates at least one of a rank that exceeds the second maximum rank or a bandwidth that exceeds the second maximum bandwidth and refraining from performing the second communication based on the rank exceeding the second maximum rank or the bandwidth exceeding the second maximum bandwidth and based on operating in accordance with the second communication configuration.

Some examples of the method, UEs, and non-transitory computer-readable medium described herein may further include operations, features, means, or instructions for transmitting a feedback message that indicates that the UE refrained from performance of the second communication.

Some examples of the method, UEs, and non-transitory computer-readable medium described herein may further include operations, features, means, or instructions for initiating, based on reception of the control message, a timer, performing a second transition, based on expiration of the timer, from operation in accordance with the second communication configuration to operation in accordance with the first communication configuration, and performing, based on the second transition, a second communication in accordance with the first communication configuration.

Some examples of the method, UEs, and non-transitory computer-readable medium described herein may further include operations, features, means, or instructions for receiving second scheduling information that schedules a set of periodic or semi-persistent scheduled communications associated with the first communication configuration and performing one or more periodic or semi-persistent scheduled communications of the set of periodic or semi-persistent scheduled communications in accordance with the first communication configuration after the transition and while operating in accordance with the second communication configuration.

Some examples of the method, UEs, and non-transitory computer-readable medium described herein may further include operations, features, means, or instructions for refraining from performing a periodic or semi-persistent scheduled communication of the set of periodic or semi-persistent scheduled communications based on the periodic or semi-persistent scheduled communication being scheduled in a same slot as the communication.

Some examples of the method, UEs, and non-transitory computer-readable medium described herein may further include operations, features, means, or instructions for receiving, after the transition and while operating in accordance with the second communication configuration, one or more first channel state information reference signals associated with the second communication configuration.

Some examples of the method, UEs, and non-transitory computer-readable medium described herein may further include operations, features, means, or instructions for refraining from monitoring, after the transition and while operating in accordance with the second communication configuration, one or more second channel state information reference signals associated with the first communication configuration.

Some examples of the method, UEs, and non-transitory computer-readable medium described herein may further include operations, features, means, or instructions for receiving, after the transition and while operating in accordance with the second communication configuration, a broadcast communication in accordance with the second communication configuration.

Some examples of the method, UEs, and non-transitory computer-readable medium described herein may further include operations, features, means, or instructions for receiving, after the transition and while operating in accordance with the second communication configuration, a broadcast communication in accordance with the first communication configuration, where the broadcast communication may be received in a different slot than the communication.

In some examples of the method, UEs, and non-transitory computer-readable medium described herein, performing the communication may include operations, features, means, or instructions for performing the communication in accordance with the first communication configuration based on the scheduling offset being greater than or equal to the scheduling offset threshold.

In some examples of the method, UEs, and non-transitory computer-readable medium described herein, the control information indicates the scheduling offset threshold.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports communication configuration adaptation in accordance with one or more aspects of the present disclosure.

FIG. 2 shows an example of timing diagrams that support communication configuration adaptation in accordance with one or more aspects of the present disclosure.

FIG. 3 shows an example of a resource diagram that supports communication configuration adaptation in accordance with one or more aspects of the present disclosure.

FIG. 4 shows an example of a timing diagrams that supports communication configuration adaptation in accordance with one or more aspects of the present disclosure.

FIG. 5 shows an example of a timing diagrams that supports communication configuration adaptation in accordance with one or more aspects of the present disclosure.

FIG. 6 shows an example of a process flow that supports communication configuration adaptation in accordance with one or more aspects of the present disclosure.

FIGS. 7 and 8 show block diagrams of devices that support communication configuration adaptation in accordance with one or more aspects of the present disclosure.

FIG. 9 shows a block diagram of a communications manager that supports communication configuration adaptation in accordance with one or more aspects of the present disclosure.

FIG. 10 shows a diagram of a system including a device that supports communication configuration adaptation in accordance with one or more aspects of the present disclosure.

FIGS. 11 and 12 show flowcharts illustrating methods that support communication configuration adaptation in accordance with one or more aspects of the present disclosure.

### DETAILED DESCRIPTION

In some wireless communication systems, user equipments (UEs) may switch between bandwidth parts (BWPs) based on network conditions without radio resource control (RRC) reconfiguration. Parameters such as a bandwidth, a sub-carrier spacing (SCS), a modulation and coding scheme (MCS) table, a channel state information (CSI) configuration, and a maximum rank, may be configured for a BWP. For example, a network entity may indicate for a UE to switch from a smaller BWP to a larger BWP (e.g., a BWP with a larger bandwidth) based on an increase in a buffer size or increase in throughput. In some examples, a network entity may indicate for a UE to switch from a larger BWP to a smaller BWP (e.g., a BWP with a smaller bandwidth) based on a decrease in a buffer size or decrease in throughput. Downlink control information (DCI) fields may depend on parameters configured for a BWP. For example, the frequency domain resource allocation (FDRA) field in a DCI may depend on the bandwidth of the operating BWP. Switching BWPs may involve significant reconfiguration at the UE to adapt to new parameter values, and accordingly may involve a switching timeline. Communications such as physical downlink shared channel (PDSCH) and physical uplink shared channel (PUSCH) communications scheduled by DCI may indicate a scheduling offset between the DCI and the scheduled communication. Absent a scheduling offset shorter than a processing time for the DCI, the UE may buffer candidate shared channel communications in order to avoid missing scheduled downlink communications.

Aspects of this disclosure relate to switching from operation in accordance with a first communication configuration (e.g., a first maximum bandwidth, a first minimum processing timeline, a first minimum scheduling offset, and/or a first maximum rank) to operation in accordance with a second, limited, communication configuration (e.g., a second smaller bandwidth, a second longer minimum processing timeline, a second longer minimum scheduling offset, and/or a second smaller maximum rank) based on a scheduling offset threshold. For example, for larger scheduling offsets, the UE may have more time to process a scheduling DCI, and accordingly may avoid high baseband processing demanded with tight processing timelines for high bandwidth or high rank communications. In some examples, for smaller scheduling offsets, the amount of data communicated may be smaller in the second, limited, communication configuration as the bandwidth and/or rank may be lower, and accordingly baseband processing may be reduced. A switch to operation in accordance with a second limited communication configuration may apply to multiple communication channels (e.g., physical uplink control channel (PUCCH), PUSCH, physical downlink control channel (PDCCH), PDSCH, channel state information reference signals (CSI-RSs), sounding reference signals (SRSs)). The DCI field sizes may be the same for both operation in accordance with a second limited communication configuration and operation in accordance with the first communication configuration. By switching communication configurations based on a scheduling offset threshold, a UE may avoid buffering candidate shared channel communications over a smaller bandwidth or reduced rank when operating in accordance with the second communication configuration.

Aspects of the disclosure are initially described in the context of wireless communications systems. Aspects of the disclosure are further illustrated by and described with reference to timing diagrams, resource diagrams, process flows, apparatus diagrams, system diagrams, and flowcharts that relate to communication configuration adaptation.

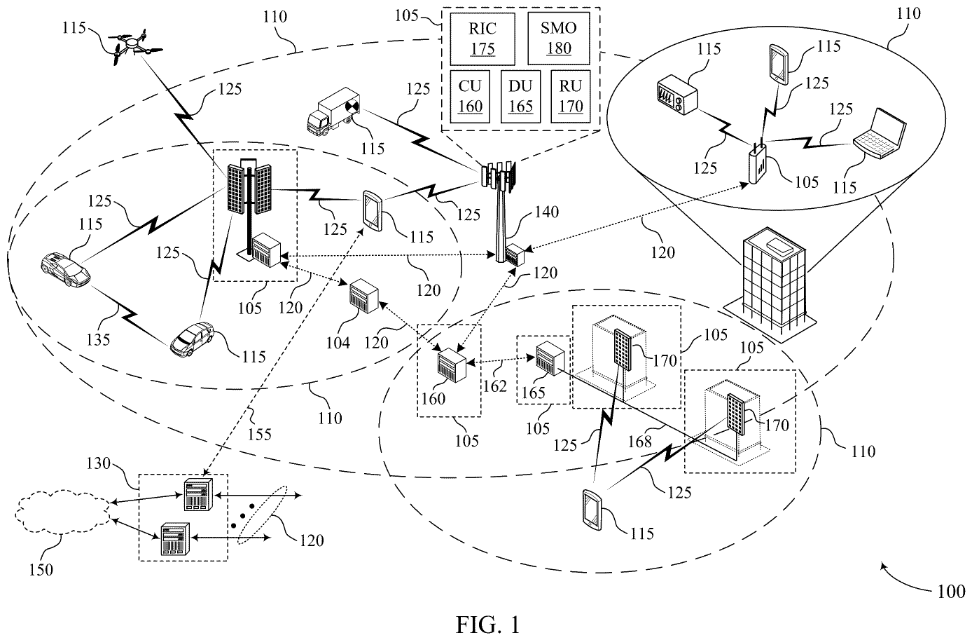

FIG. 1 shows an example of a wireless communications system 100 that supports communication configuration adaptation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support communication configuration adaptation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5 GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

UEs 115 may switch between BWPs based on network conditions with or without RRC reconfiguration. Parameters such as a bandwidth, an SCS, an MCS table, a CSI configuration, and a maximum rank, may be configured for a BWP. BWPs may be switched using DCI or an RRC reconfiguration. For example, a network entity 105 may indicate for a UE 115 to switch from a small BWP to a larger BWP (e.g., a BWP with a larger bandwidth) based on an increase in a buffer size or increase in throughput. In some examples, a network entity 105 may indicate for a UE 115 to switch from a large BWP to a smaller BWP (e.g., a BWP with a smaller bandwidth) based on a decrease in a buffer size or decrease in throughput. DCI fields may depend on parameters configured for a BWP. For example, the FDRA field in a DCI may depend on the bandwidth of the operating BWP. In some examples, some of the fields in a DCI may not exist based on the active BWP. Switching BWPs may involve significant reconfiguration at the UE 115 to adapt to new parameter values, and accordingly may involve a switching timeline. For example, BWP switching timelines may be defined as Type 1 (fast) and Type 2 (slow) as shown in Table 1. In Table 1, if the BWP switch involves changing of SCS, the BWP switch delay may be determined by the smaller SCS between the SCS before the BWP switch and the SCS after the BRP switch. BWP switching capability may be reported by the UE 115 to the network entity 105 in a UE capability report.

TABLE 1

| | NR slot length | BWP Switch Delay T_{BWPswitchDelay} (slots) | |
|---|---|---|---|
| μ | (milliseconds) | Type 1 | Type 2 |
| 0 | 1 | 1 | 3 |
| 1 | 0.5 | 2 | 5 |
| 2 | 0.25 | 3 | 9 |
| 3 | 0.125 | 6 | 18 |

As shown in Table 1, switching BWPs may involve a duration of one or more slots. Communications such as PDSCH and PUSCH communications scheduled by DCI may indicate a scheduling offset between the DCI and the scheduled communication. Absent a scheduling offset, or absent a scheduling offset shorter than a processing time for the DCI, the UE 115 may buffer candidate shared channel communications in order to avoid missing scheduled downlink communications.

In some aspects, a UE 115 may switch from operation in accordance with a first communication configuration (e.g., a first maximum bandwidth, a first minimum processing timeline, a first minimum scheduling offset, and/or a first maximum rank) to operation in accordance with a second, limited, communication configuration (e.g., a second smaller, bandwidth, a second longer minimum processing timeline, a second longer minimum scheduling offset, and/or a second smaller, maximum rank) without significant reconfiguration in the baseband processor. For example, such switching may be based on a scheduling offset threshold. For example, for larger scheduling offsets, the UE may have more time to process a scheduling DCI, and accordingly may avoid high baseband processing demanded with tight processing timelines for high bandwidth or high rank communications. In some examples, for smaller scheduling offsets, the amount of data communicated may be smaller in the second, limited, communication configuration as the bandwidth and/or rank may be lower, and accordingly baseband processing may be reduced.

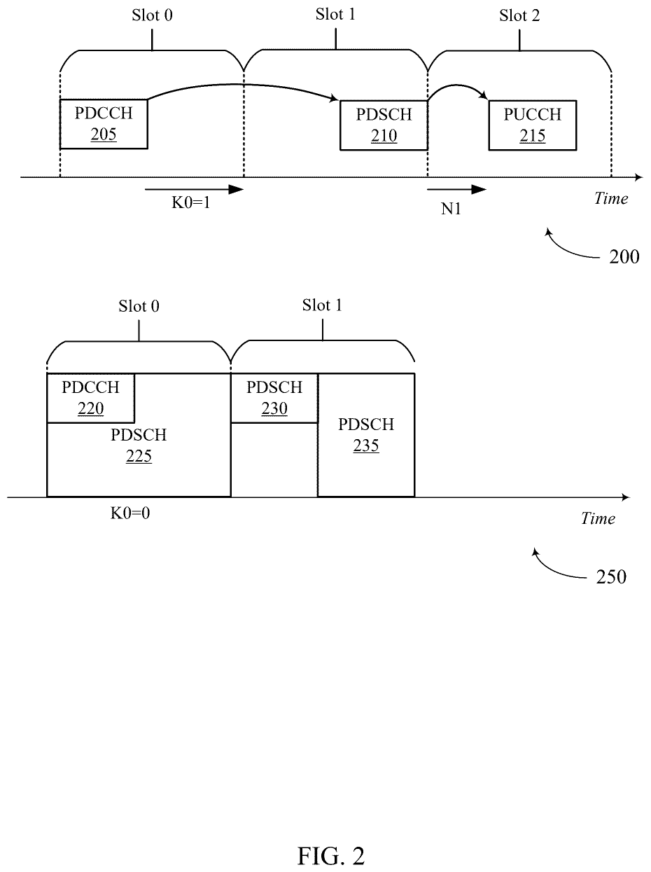

FIG. 2 shows an example of a timing diagram 200 and a timing diagram 250 that support communication configuration adaptation in accordance with one or more aspects of the present disclosure. The timing diagram 200 and the timing diagram 250 may implement or may be implemented by aspects of the wireless communications system 100. For example, the timing diagram 200 and the timing diagram 250 may illustrate timing of communications between a UE 115 and a network entity 105 as described herein.

NR communications may involve multiple times and scheduling offsets. For example, K0 may refer to the gap in slots between a PDCCH and a PDSCH scheduled by the PDCCH. Similarly, K2 may refer to the gap in slots between a PDCCH and a PUSCH scheduled by the PDCCH. For example, in the timing diagram 200, the PDCCH 205 in slot 0 schedules the PDSCH 210 in slot 1, and accordingly K0=1. A DCI in the PDCCH 205 may indicate the K0 for the PDSCH 210 scheduled by the PDCCH 205. As another example, in the timing diagram 250, the PDCCH 220 in slot 0 schedules the PDSCH 225 in slot 0, and accordingly K0=0. Similarly, in the timing diagram 250, the PDCCH 230 in slot 1 schedules the PDSCH 235 in slot 1, and accordingly K0=0. Accordingly, in NR, the minimum value for K0, K1, and K2 may be 0 (e.g., NR may allow same slot scheduling).

N1 may refer to the gap between the end of a PDSCH and the earliest possible HARQ feedback. N1 may be defined in symbols. For example, as shown in the timing diagram 200, N1 may be the gap between the PDSCH 210 and the PUCCH 215 that conveys HARQ feedback for the PDSCH 210.

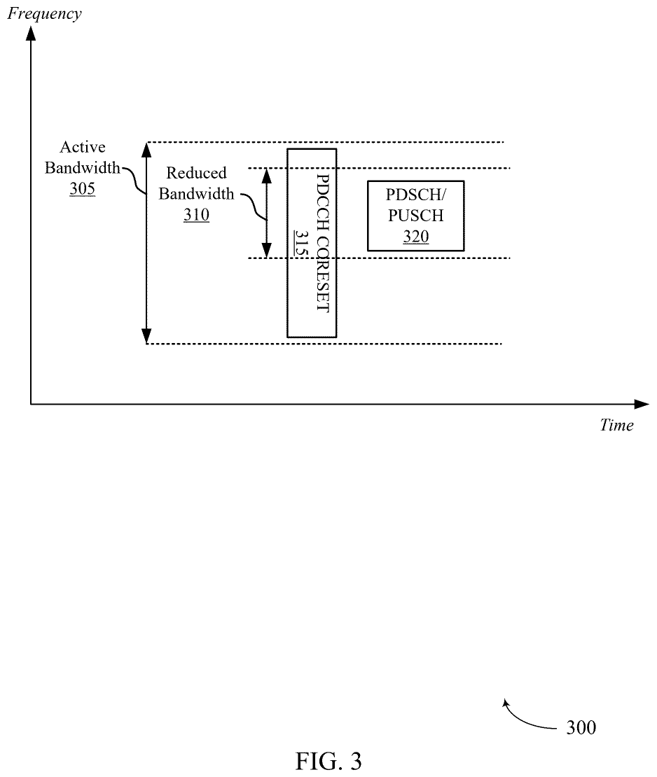

FIG. 3 shows an example of a resource diagram 300 that supports communication configuration adaptation in accordance with one or more aspects of the present disclosure. The resource diagram 300 may implement or may be implemented by aspects of the wireless communications system 100, the timing diagram 200, or the timing diagram 250. For example, the resource diagram 300 may illustrate switching between bandwidths configured for communications between a UE 115 and a network entity 105 as described herein.

As described herein, a UE 115 may be configured with a first communication configuration (e.g., a first maximum bandwidth, a first minimum processing timeline, a first minimum scheduling offset, and/or a first maximum rank) and a second, limited, communication configuration (e.g., a second smaller bandwidth, a second longer minimum processing timeline, a second longer minimum scheduling offset, and/or a second smaller maximum rank). The UE 115 may switch between operation in accordance with the first communication configuration and the second communication configuration more quickly than switching between BWPs. For example, while operating in the second, limited, communication configuration, the UE 115 may expect to receive or transmit signaling in a reduced bandwidth 310 (e.g., as compared to an active bandwidth 305 configured for the UE 115). In some examples, while operating in the second, limited, communication configuration, the UE 115 may expect to receive or transmit signaling with a reduced maximum rank, with a longer minimum scheduling offset, with a longer minimum processing timeline, or with a reduced quantity of antennas.

In some examples, control signaling received via a PDCCH 315 (e.g., DCI) may indicate to switch from operation in accordance with the first communication configuration to operation in accordance with the second communication configuration. The second configuration may apply to multiple channels or reference signals (e.g., PDCCH, PDSCH, PUCCH, PUSCH, CSI CSI-RSs, and SRSs). For example, the UE 115 may apply the second communication configuration for a shared channel communication 320 (e.g., a PUSCH or a PDSCH) scheduled by the PDCCH 315.

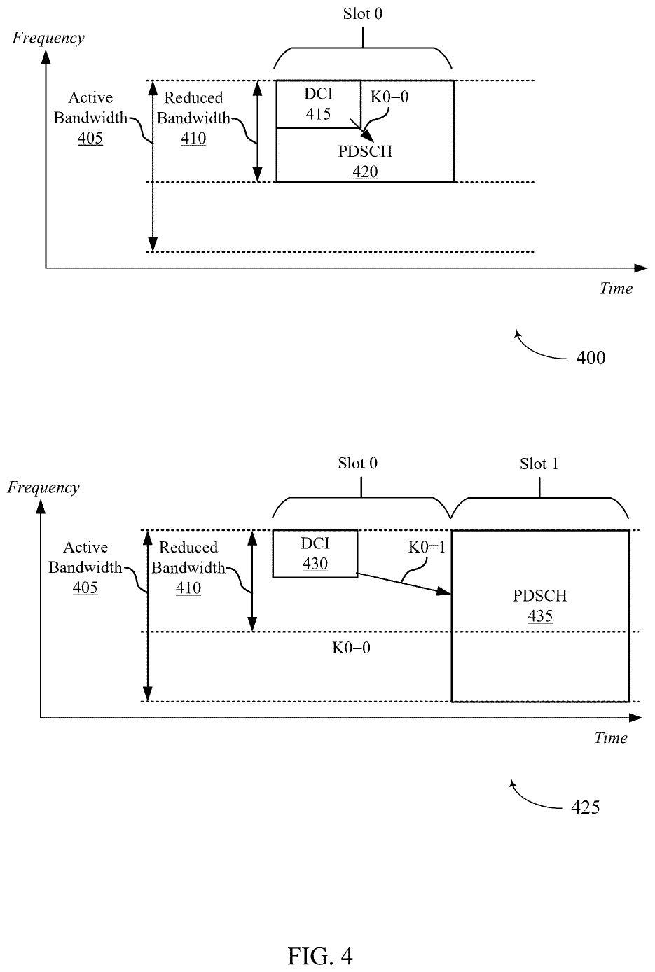

FIG. 4 shows an example of a timing diagram 400 and a timing diagram 425 that support communication configuration adaptation in accordance with one or more aspects of the present disclosure. The timing diagram 400 and the timing diagram 425 may implement or may be implemented by aspects of the wireless communications system 100, the timing diagram 200, the timing diagram 250, or the resource diagram 300.

As described herein, a UE 115 may be configured with a first communication configuration (e.g., a first maximum bandwidth, a first minimum processing timeline, a first minimum scheduling offset, and/or a first maximum rank) and a second, limited, communication configuration (e.g., a second smaller bandwidth, a second longer minimum processing timeline, a second longer minimum scheduling offset, and/or a second smaller maximum rank). The UE 115 may switch between operation in accordance with the first communication configuration and the second communication configuration more quickly than switching between BWPs. For example, while operating in the second, limited, communication configuration, the UE 115 may expect to receive or transmit signaling in a reduced bandwidth 410 (e.g., as compared to an active bandwidth 405 configured for the UE 115).

In some examples, switching between the first communication configuration and the second communication configuration may be based on the scheduling offset and/or processing timeline for a scheduled communication. For example, the UE 115 may switch to operation in accordance with the second communication configuration when K0 or K2 for a PDSCH or a PUSCH are below a scheduling offset threshold. Switching to operation in accordance with the second communication configuration when K0 for a PDSCH is below a scheduling offset threshold may reduce the amount of data for the UE to buffer from candidate PDSCHs. For example, if the scheduling offset threshold is K0/K2=1, if a DCI 415 indicates K0=0 as shown in the timing diagram 400, the UE 115 may operate in accordance with the second communication configuration for reception of the PDSCH 420 scheduled by the DCI 415. For example, the UE 115 may use the reduced bandwidth 410, the second smaller maximum rank, the longer minimum processing timeline, and/or the longer minimum scheduling offset for reception of the PDSCH 420 scheduled by the DCI 415. In some examples, if the scheduling offset threshold is K0/K2=1, if a DCI 430 indicates K0=1 as shown in the timing diagram 425, the UE 115 may operate in accordance with the first communication configuration for reception of the PDSCH 435 scheduled by the DCI 430. For example, the UE 115 may use the active bandwidth 405, the first (e.g., larger) maximum rank, the first (e.g., shorter) minimum processing timeline, and/or the first (e.g., shorter) minimum scheduling offset for reception of the PDSCH 435 scheduled by the DCI 430.

In some examples, once the UE 115 switches to the second communication configuration (e.g., as shown in the timing diagram 400), the UE 115 may use the second communication configuration for multiple channels/signals (e.g., for PUSCH, PDSCH, PUCCH, CSI-RS, SRS) until the UE 115 switches back to operation in accordance with the first communication configuration. In some examples, once the UE 115 switches to the second communication configuration, the UE 115 may only monitor PDCCH candidates that satisfy the parameters of the second communication configuration (e.g., satisfy the second smaller bandwidth, the second longer minimum processing timeline, the second longer minimum scheduling offset, and/or the second smaller maximum rank) and may not monitor other PDCCH candidates. In some examples, once the UE 115 switches to the second communication configuration, the UE 115 may monitor a separate set of PDCCH candidates. For example, control signaling such as RRC may configure the separate set of PDCCH candidates for the UE 115 to monitor while the UE 115 operates in accordance with the second communication configuration. In some examples, a network entity 105 may transmit signaling (e.g., via RRC, DCI, a MAC-CE, or via a BWP configuration) that enables switching between the first communication configuration and the second communication configuration. In some such examples, the UE 115 may switch between the first communication configuration and the second communication configuration based on a scheduling offset threshold, as shown in FIG. 4.

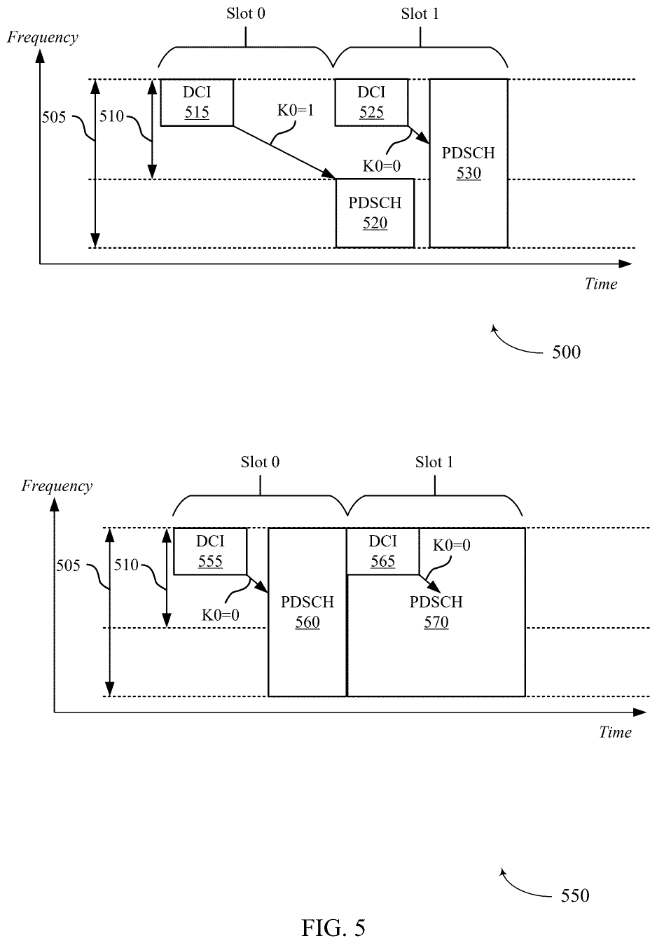

In some examples, a network entity 105 may transmit explicit signaling to a UE 115 to indicate to enable and/or disable the second communication configuration (e.g., to switch between the first communication configuration and the second communication configuration). For example, the network entity 105 may transmit DCI signaling, a BWP configuration, a MAC-CE, or RRC signaling to enable and/or disable the second communication configuration. In some examples, disabling the second communication configuration may be implicit (e.g., may be based on a DCI that schedules a transmission/reception that does not follow the second communication configuration as shown in FIG. 5). In some examples, disabling the second communication configuration (e.g., switching back to operation in accordance with the first communication configuration) may be based on a timer. For example, the value of the timer (e.g., length of the timer) may be configured or specified via RRC signaling. In some examples, the UE 115 may reset the timer after each DCI or after each DCI that does not follow the second communication configuration. The UE 115 may switch back to operation in accordance with the first communication configuration after the expiration of the timer.

In some examples, while operating in accordance with the second communication configuration, the UE 115 may receive broadcast signaling from a network entity that does not comply with the parameters of the second communication configuration (e.g., that exceed the reduced bandwidth 410, that exceed the second maximum rank, that are longer than the second minimum processing timeline, and/or are longer than the second minimum scheduling offset). For example, the second communication configuration may be a superset of scheduling options for broadcast signaling. In some examples, the UE 115 may not be expected to receive unicast signaling that follows the parameters of the second communication configuration in a same slot as broadcast signaling (e.g., the UE 115 may switch to operation in accordance with the first communication configuration in a slot in which the UE 115 expects to receive broadcast signaling). In some examples, the second communication configuration may also apply to broadcast signaling.

In some examples, periodically scheduled and/or semi-persistent scheduled signals may be exempt from the parameters of the second communication configuration (e.g., the UE 115 may use the first communication configuration for transmission/reception of periodically scheduled and/or semi-persistent scheduled signals even when the UE 115 operates in accordance with the second communication configuration). An exception may be that if an activation signal (e.g., DCI) for switching to operation in accordance with the second communication configuration is in a same slot as a periodically scheduled and/or semi-persistent scheduled signal, the periodically scheduled and/or semi-persistent scheduled signal may not be exempt from the parameters of the second communication configuration. For example, if the UE is scheduled to transmit a periodically scheduled and/or semi-persistent scheduled signal in the slot 0 in the timing diagram 400, the second communication configuration may apply to the periodically scheduled and/or semi-persistent scheduled signal in slot 0. In some examples, slots with periodically scheduled and/or semi-persistent scheduled signals may be exempt from the second communication configuration (e.g., the UE 115 may switch to operation in accordance with the first communication configuration in a slot in which the UE 115 is scheduled to transmit or receive a periodically scheduled and/or semi-persistent scheduled signal). In some examples, whether periodically scheduled and/or semi-persistent scheduled signals may be exempt from the parameters of second communication configuration may be configured for a UE 115 by a network entity 105 (e.g., via RRC signaling or DCI).

In some examples, while operating in accordance with the second communication configuration, the UE 115 may expect CSI-RS to follow the parameters of the second communication configuration. In some examples, while operating in accordance with the second communication configuration, the UE 115 may calculate and report CSI for CSI-RSs that follow the parameters of the second communication configuration (e.g., for CSI-RSs within the reduced bandwidth 410) and may not calculate and report CSI for CSI-RSs that do not follow the parameters of the second communication configuration (e.g., for CSI-RSs outside the reduced bandwidth 410).

In some examples, if the UE 115 is scheduled with a signal that does not follow the parameters of the second communication configuration while operating in accordance with the second communication configuration (e.g., receives a DCI that schedules a reception/transmission that exceeds the reduced bandwidth 410 or exceeds the second maximum rank while operating in accordance with the second communication configuration), the UE 115 may not be expected to receive or transmit the signal. In some examples, as described with reference to FIG. 5, the UE 115 may assume that the scheduling of the signal implicitly disables the second communication configuration, and the UE 115 may switch back to operation in accordance with the first communication configuration. In some examples, based on the scheduling of the signal that does not follow the parameters of the second communication configuration while operating in accordance with the second communication configuration, the UE 115 may send feedback to the network that the UE 115 skipped reception or transmission of the signal. For example, the feedback may be a negative acknowledgment (NACK) or a special value for downlink grants with HARQ-acknowledgment (HARQ-ACK) feedback. In some examples, the feedback may be a special uplink control information (UCI) for uplink transmissions or downlink signals without HARQ-ACK feedback (e.g., if the skipped signal is a signal with no HARQ feedback mechanism such as a CSI-RS).

FIG. 5 shows an example of a timing diagram 500 and a timing diagram 550 that support communication configuration adaptation in accordance with one or more aspects of the present disclosure. The timing diagram 500 and the timing diagram 550 may implement or may be implemented by aspects of the wireless communications system 100, the timing diagram 200, the timing diagram 250, the resource diagram 300, the timing diagram 400, or the timing diagram 425.

As described herein, a UE 115 may be configured with a first communication configuration (e.g., a first maximum bandwidth, a first minimum processing timeline, a first minimum scheduling offset, and/or a first maximum rank) and a second, limited, communication configuration (e.g., a second smaller bandwidth, a second longer minimum processing timeline, a second longer minimum scheduling offset, and/or a second smaller maximum rank). The UE 115 may switch between operation in accordance with the first communication configuration and the second communication configuration more quickly than switching between BWPs. For example, while operating in the second, limited, communication configuration, the UE 115 may expect to receive or transmit signaling in a reduced bandwidth 510 (e.g., as compared to an active bandwidth 505 configured for the UE 115). In some examples, as described with reference to FIG. 4, the UE 115 may switch to operation in accordance with the second communication configuration based on reception of a DCI that indicates a K0/K1 below a scheduling offset threshold.

In some examples, disabling the second communication configuration (e.g., switching back to operation in accordance with the first communication configuration) may be implicit. For example, as shown in the timing diagram 500, the UE 115 may be operating in accordance with the second communication configuration in slot 0. The UE 115 may receive a DCI 515 in slot 0 that schedules a PDSCH 520 in slot 1 (e.g., the DCI 515 indicates K0=1). The DCI 515 may schedule the PDSCH 520 outside of the parameters of the second communication configuration. For example, as shown in the timing diagram, the PDSCH 520 may be scheduled within the active bandwidth 505 but outside of the reduced bandwidth 510. The DCI 515 scheduling the PDSCH 520 outside of the reduced bandwidth 510 may implicitly disable the second communication configuration starting at the subsequent slot (e.g., may indicate for the UE 115 to switch back to operation in accordance with the first communication configuration starting at slot 1). For example, the UE 115 may receive the PDSCH 520 in slot 1 in the active bandwidth 505. In slot 1, the UE 115 may receive a DCI 525 that schedules a PDSCH 530 in slot 1 (e.g., K0=0) that extends outside of the reduced bandwidth 510. The UE 115 may receive both the PDSCH 520 and the PDSCH 530 in slot 1 based on switching back to operation in accordance with the first communication configuration.

In some examples, as shown in the timing diagram 550, the UE 115 may be operating in accordance with the second communication configuration in slot 0. The UE 115 may receive a DCI 555 in slot 0 that schedules a PDSCH 560 in slot 0 (e.g., the DCI 515 indicates K0=0). The DCI 555 may schedule the PDSCH 560 outside of the parameters of the second communication configuration. For example, as shown in the timing diagram, the PDSCH 560 may be scheduled within the active bandwidth 505 but outside of the reduced bandwidth 510. The DCI 555 scheduling the PDSCH 560 outside of the reduced bandwidth 510 may implicitly disable the second communication configuration (e.g., may indicate for the UE 115 to switch back to operation in accordance with the first communication configuration). The UE 115 my switch to operation in accordance with the first communication configuration starting at the subsequent slot, slot 1. In slot 1, the UE 115 may receive a DCI 565 that schedules a PDSCH 570 in slot 1 (e.g., K0=0) that extends outside of the reduced bandwidth 510. The UE 115 may be expected to decode and receive the PDSCH 570 in slot 1 as the UE 115 switches to the first communication configuration for slot 1. In some examples, the UE 115 may not be expected to switch to operation in accordance with the first communication configuration within the same slot (slot 0) as the DCI that implicitly disables the second communication configuration, and accordingly the UE 115 may not be expected to receive the PDSCH 560.

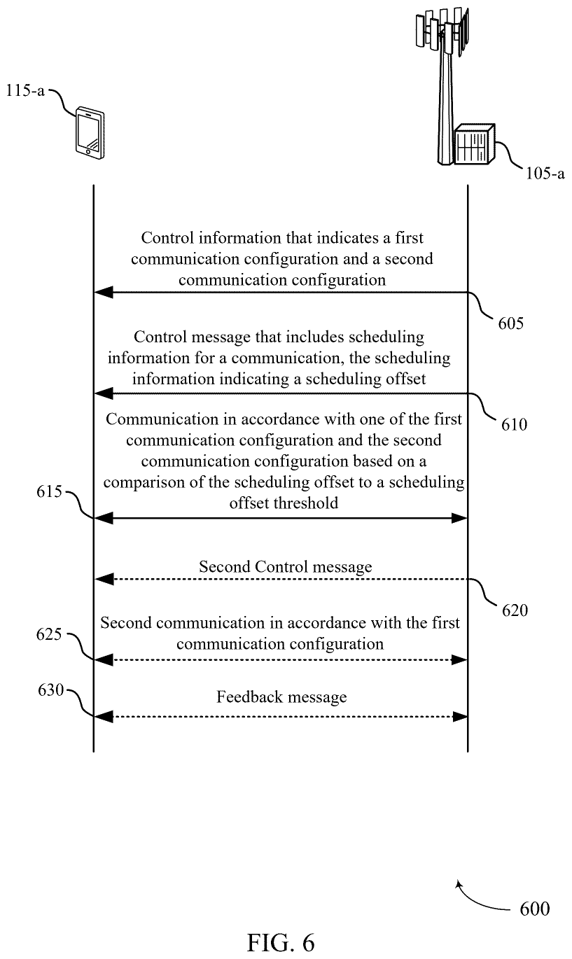

FIG. 6 shows an example of a process flow 600 that supports communication configuration adaptation in accordance with one or more aspects of the present disclosure. The process flow 600 may include a UE 115-a and a network entity 105-a, which may be examples of a UE 115 and a network entity 105 as described herein. For example, the UE 115-a and the network entity 105-a may communicate via a communication link 125 as described herein. In the following description of the process flow 600, the communications between the network entity 105-a and the UE 115-a may be transmitted in a different order than the example order shown, or the operations performed by the network entity 105-a and the UE 115-a may be performed in different orders or at different times. Some operations may also be omitted from the process flow 600, and other operations may be added to the process flow 600.

At 605, the UE 115-a may receive control information from the network entity 105-a that indicates a first communication configuration and a second communication configuration. For example, the control information may be received by the UE 115-a via RRC signaling, DCI signaling, a MAC-CE, a BWP configuration, or a combination thereof. The first communication configuration may be associated with at least one of a first maximum bandwidth, a first minimum processing timeline, a first minimum scheduling offset, or a first maximum rank. The second communication configuration may be associated with at least one of a second maximum bandwidth, a second minimum processing timeline, a second minimum scheduling offset, or a second maximum rank. One or more of: the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank.

At 610, the UE 115-a may receive a control message from the network entity 105-a that includes scheduling information for a communication. The scheduling information may indicate a scheduling offset associated with the communication.

At 615, the UE 115-a may perform the communication with the network entity 105-a in accordance with one of the first communication configuration or the second communication configuration based on comparison of the scheduling offset to a scheduling offset threshold associated with the second communication configuration. In some examples, the scheduling offset threshold may be indicated by the control information at 605. In some examples, the scheduling offset threshold may be predefined or standardized.

In some examples, the UE 115-a may perform a transition from operation in accordance with the first communication configuration to operation in accordance with the second communication configuration based on the scheduling offset being greater than the scheduling offset threshold. In some examples, the UE 115-a may perform a transition from operation in accordance with the first communication configuration to operation in accordance with the second communication configuration based on the scheduling offset being less than the scheduling offset threshold. In some examples, performing the communication at 615 may involve performing the communication in accordance with the second communication configuration based on the transition to the second communication configuration. For example, the UE 115-a may perform the communication at 615 in accordance with the second communication configuration based on the transition to the second communication configuration. In some examples, the scheduling offset may be K0 or K2 as described herein, and the UE 115-a may operate in accordance with the second communication configuration (e.g., may transition to the second communication configuration) when K0 or K2 is below a threshold and the UE 115-a may operate in accordance with the first communication configuration (e.g., may transition to the first communication configuration) when K0 or K2 is above at or above the threshold. For example the threshold may be 1 slot.

In some examples, the control message received at 610 may include a field that has a value that indicates to operate in accordance with the second communication configuration, and transitioning from operation in accordance with the first communication configuration to operation in accordance with the second communication configuration may be based on the field. In some examples, at 620, the UE 115-a may receive, after the control message at 610, a second control message that includes the field, where the field has a second value that indicates to operate in accordance with the first communication configuration. In such examples, the UE 115 may perform a second transition from operation in accordance with the first communication configuration to operation in accordance with the second communication configuration based on the second control message. In such examples, at 625 the UE 115 may perform, after the second transition, a second communication in accordance with the first communication configuration.

In some examples, where the UE 115-a transitioned to the second communication configuration, the UE 115-a may monitor, after the transition and while operating in accordance with the second communication configuration, one or more first PDCCH candidates associated with the second communication configuration. In such examples, the UE 115-a may refrain from monitoring, after the transition and while operating in accordance with the second communication configuration, one or more second PDCCH candidates associated with the first communication configuration.

In some examples, where the UE 115-a transitioned to the second communication configuration, at 620 the UE 115-a may receive, after reception of the control message at 610, a second control message that includes second scheduling information for a second communication, where the second scheduling information indicates a second scheduling offset associated with the communication. In some examples, the UE 115-a may perform a second transition, based on the second scheduling offset being greater than or equal to the scheduling offset threshold, from operation in accordance with the second communication configuration to operation in accordance with the first communication configuration. In some examples, the UE 115-a may perform a second transition, based on the second scheduling offset being less than the scheduling offset threshold, from operation in accordance with the second communication configuration to operation in accordance with the first communication configuration. In some examples, at 625, the UE 115-a may perform, based on the second transition, the second communication in accordance with the first communication configuration.

In some examples, where the UE 115-a transitioned to the second communication configuration, at 620 the UE 115-a may receive, after reception of the control message at 610, a second control message that includes second scheduling information for a second communication, where the second scheduling information indicates a second scheduling offset associated with the communication. In such examples, the UE 115-a may refrain from performing the second communication based on the second scheduling offset being less than the scheduling offset threshold and based on operating in accordance with the second communication configuration. In some such examples, at 630 the UE 115-a may transmit a feedback message that indicates that the UE 115-a refrained from performance of the second communication.

In some examples, where the UE 115-a transitioned to the second communication configuration, at 620 the UE 115-a may receive, after reception of the control message at 610, a second control message that includes second scheduling information for a second communication, where the second scheduling information indicates at least one of a rank that exceeds the second maximum rank or a bandwidth that exceeds the second maximum bandwidth. In some such examples, the UE 115-a may perform a second transition, based on the rank exceeding the second maximum rank or the bandwidth exceeding the second maximum bandwidth, from operation in accordance with the second communication configuration to operation in accordance with the first communication configuration. In such examples, at 625, the UE 115-a may perform, based on the second transition, the second communication in accordance with the first communication configuration.

In some examples, where the UE 115-a transitioned to the second communication configuration, at 620 the UE 115-a may receive, after reception of the control message at 610, a second control message that includes second scheduling information for a second communication, where the second scheduling information indicates at least one of a rank that exceeds the second maximum rank or a bandwidth that exceeds the second maximum bandwidth. In some such examples, the UE 115-a may refrain from performing the second communication based on the rank exceeding the second maximum rank or the bandwidth exceeding the second maximum bandwidth and based on operating in accordance with the second communication configuration. In some such examples, at 630 the UE 115-a may transmit a feedback message that indicates that the UE refrained from performance of the second communication.

In some examples, the UE 115-a may: initiate, based on reception of the control message at 610, a timer; perform a second transition, based on expiration of the timer, from operation in accordance with the second communication configuration to operation in accordance with the first communication configuration; perform, based at least in part on the second transition, a second communication at 625 in accordance with the first communication configuration.

In some examples, where the UE 115-a transitioned to the second communication configuration, the UE 115-a may: receive second scheduling information that schedules a set of periodic or semi-persistent scheduled communications associated with the first communication configuration; and perform one or more periodic or semi-persistent scheduled communications of the set of periodic or semi-persistent scheduled communications in accordance with the first communication configuration after the transition and while operating in accordance with the second communication configuration. In some such examples, the UE 115-a may refrain from performing a periodic or semi-persistent scheduled communication of the set of periodic or semi-persistent scheduled communications based on the periodic or semi-persistent scheduled communication being scheduled in a same slot as the communication at 615.

In some examples, where the UE 115-a transitioned to the second communication configuration, the UE 115-a may receive, after the transition and while operating in accordance with the second communication configuration, one or more first CSI-RSs associated with the second communication configuration. In some such examples, the UE 115-a may refrain from monitoring, after the transition and while operating in accordance with the second communication configuration, one or more second CSI-RSs associated with the first communication configuration.

In some examples, where the UE 115-a transitioned to the second communication configuration, the UE 115-a may receive, after the transition and while operating in accordance with the second communication configuration, a broadcast communication in accordance with the second communication configuration.

In some examples, where the UE 115-a transitioned to the second communication configuration, the UE 115-a may receive, after the transition and while operating in accordance with the second communication configuration, a broadcast communication in accordance with the first communication configuration, where the broadcast communication is received in a different slot than the communication.

In some examples, the UE 115-a may perform the communication at 615 in accordance with the first communication configuration based on the scheduling offset being greater than or equal to the scheduling offset threshold.

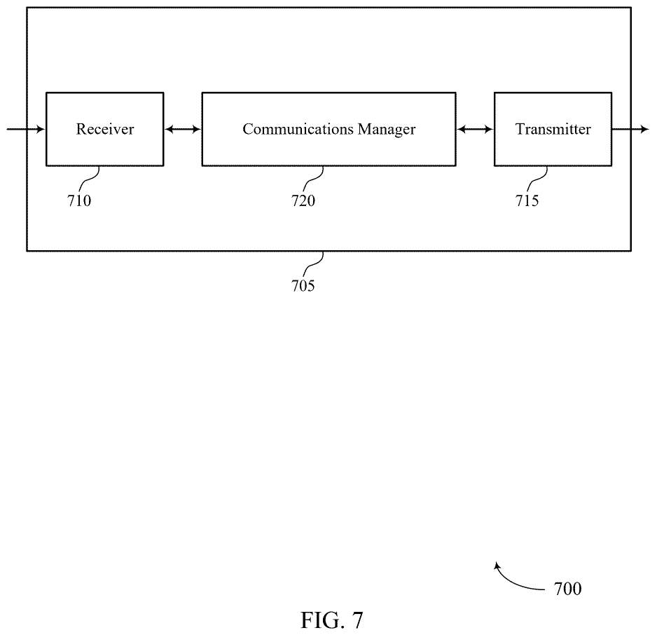

FIG. 7 shows a block diagram 700 of a device 705 that supports communication configuration adaptation in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to communication configuration adaptation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to communication configuration adaptation). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of communication configuration adaptation as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving control information that indicates a first communication configuration and a second communication configuration, where the first communication configuration is associated with at least one of a first maximum bandwidth, a first minimum processing timeline, a first minimum scheduling offset, or a first maximum rank, where the second communication configuration is associated with at least one of a second maximum bandwidth, a second minimum processing timeline, a second minimum scheduling offset, or a second maximum rank, and where one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank. The communications manager 720 is capable of, configured to, or operable to support a means for receiving a control message that includes scheduling information for a communication, where the scheduling information indicates a scheduling offset associated with the communication. The communications manager 720 is capable of, configured to, or operable to support a means for performing the communication in accordance with one of the first communication configuration or the second communication configuration based on comparison of the scheduling offset to a scheduling offset threshold associated with the second communication configuration.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced power consumption and more efficient utilization of communication resources.

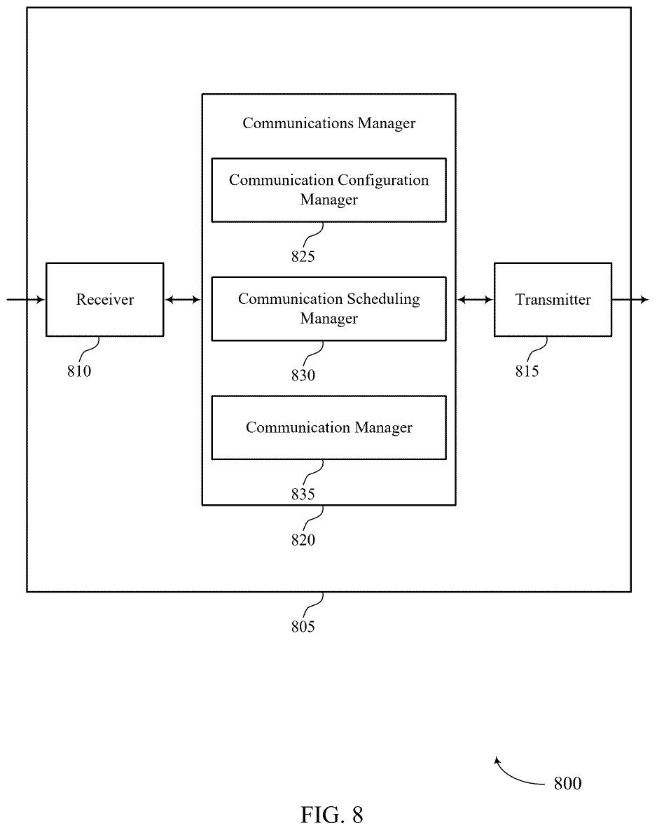

FIG. 8 shows a block diagram 800 of a device 805 that supports communication configuration adaptation in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to communication configuration adaptation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to communication configuration adaptation). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of communication configuration adaptation as described herein. For example, the communications manager 820 may include a communication configuration manager 825, a communication scheduling manager 830, a communication manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The communication configuration manager 825 is capable of, configured to, or operable to support a means for receiving control information that indicates a first communication configuration and a second communication configuration, where the first communication configuration is associated with at least one of a first maximum bandwidth, a first minimum processing timeline, a first minimum scheduling offset, or a first maximum rank, where the second communication configuration is associated with at least one of a second maximum bandwidth, a second minimum processing timeline, a second minimum scheduling offset, or a second maximum rank, and where one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank. The communication scheduling manager 830 is capable of, configured to, or operable to support a means for receiving a control message that includes scheduling information for a communication, where the scheduling information indicates a scheduling offset associated with the communication. The communication manager 835 is capable of, configured to, or operable to support a means for performing the communication in accordance with one of the first communication configuration or the second communication configuration based on comparison of the scheduling offset to a scheduling offset threshold associated with the second communication configuration.

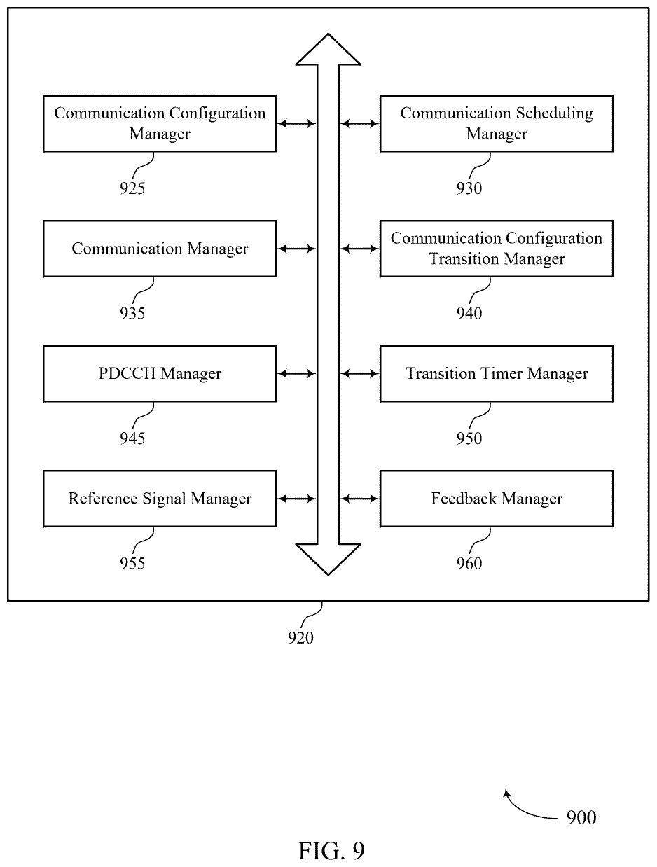

FIG. 9 shows a block diagram 900 of a communications manager 920 that supports communication configuration adaptation in accordance with one or more aspects of the present disclosure. The communications manager 920 may be an example of aspects of a communications manager 720, a communications manager 820, or both, as described herein. The communications manager 920, or various components thereof, may be an example of means for performing various aspects of communication configuration adaptation as described herein. For example, the communications manager 920 may include a communication configuration manager 925, a communication scheduling manager 930, a communication manager 935, a communication configuration transition manager 940, a PDCCH manager 945, a transition timer manager 950, a reference signal manager 955, a feedback manager 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The communication configuration manager 925 is capable of, configured to, or operable to support a means for receiving control information that indicates a first communication configuration and a second communication configuration, where the first communication configuration is associated with at least one of a first maximum bandwidth, a first minimum processing timeline, a first minimum scheduling offset, or a first maximum rank, where the second communication configuration is associated with at least one of a second maximum bandwidth, a second minimum processing timeline, a second minimum scheduling offset, or a second maximum rank, and where one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank. The communication scheduling manager 930 is capable of, configured to, or operable to support a means for receiving a control message that includes scheduling information for a communication, where the scheduling information indicates a scheduling offset associated with the communication. The communication manager 935 is capable of, configured to, or operable to support a means for performing the communication in accordance with one of the first communication configuration or the second communication configuration based on comparison of the scheduling offset to a scheduling offset threshold associated with the second communication configuration.

In some examples, the communication configuration transition manager 940 is capable of, configured to, or operable to support a means for performing a transition from operation in accordance with the first communication configuration to operation in accordance with the second communication configuration based on the scheduling offset being greater than the scheduling offset threshold, and where performing the communication includes performing the communication in accordance with the second communication configuration based on the transition.

In some examples, the communication configuration transition manager 940 is capable of, configured to, or operable to support a means for performing a transition from operation in accordance with the first communication configuration to operation in accordance with the second communication configuration based on the scheduling offset being less than the scheduling offset threshold, and where performing the communication includes performing the communication in accordance with the second communication configuration based on the transition.

In some examples, the PDCCH manager 945 is capable of, configured to, or operable to support a means for monitoring, after the transition and while operating in accordance with the second communication configuration, one or more first PDCCH candidates associated with the second communication configuration. In some examples, the PDCCH manager 945 is capable of, configured to, or operable to support a means for refraining from monitoring, after the transition and while operating in accordance with the second communication configuration, one or more second PDCCH candidates associated with the first communication configuration.

In some examples, the control message includes a field that has a value that indicates to operate in accordance with the second communication configuration. In some examples, the transition is based on the field.

In some examples, the communication configuration manager 925 is capable of, configured to, or operable to support a means for receiving a second control message that includes the field, where the field has a second value that indicates to operate in accordance with the first communication configuration. In some examples, the communication configuration transition manager 940 is capable of, configured to, or operable to support a means for performing a second transition from operation in accordance with the first communication configuration to operation in accordance with the second communication configuration based on the second control message. In some examples, the communication manager 935 is capable of, configured to, or operable to support a means for performing, after the second transition, a second communication in accordance with the first communication configuration.

In some examples, the communication scheduling manager 930 is capable of, configured to, or operable to support a means for receiving, after reception of the control message, a second control message that includes second scheduling information for a second communication, where the second scheduling information indicates a second scheduling offset associated with the communication. In some examples, the communication configuration transition manager 940 is capable of, configured to, or operable to support a means for performing a second transition, based on the second scheduling offset being greater than or equal to the scheduling offset threshold, from operation in accordance with the second communication configuration to operation in accordance with the first communication configuration. In some examples, the communication manager 935 is capable of, configured to, or operable to support a means for performing, based on the second transition, the second communication in accordance with the first communication configuration.

In some examples, the communication scheduling manager 930 is capable of, configured to, or operable to support a means for receiving, after reception of the control message, a second control message that includes second scheduling information for a second communication, where the second scheduling information indicates a second scheduling offset associated with the communication. In some examples, the communication manager 935 is capable of, configured to, or operable to support a means for refraining from performing the second communication based on the second scheduling offset being less than the scheduling offset threshold and based on operating in accordance with the second communication configuration.

In some examples, the feedback manager 960 is capable of, configured to, or operable to support a means for transmitting a feedback message that indicates that the UE refrained from performance of the second communication.

In some examples, the communication scheduling manager 930 is capable of, configured to, or operable to support a means for receiving, after reception of the control message, a second control message that includes second scheduling information for a second communication, where the second scheduling information indicates at least one of a rank that exceeds the second maximum rank or a bandwidth that exceeds the second maximum bandwidth. In some examples, the communication configuration transition manager 940 is capable of, configured to, or operable to support a means for performing a second transition, based on the rank exceeding the second maximum rank or the bandwidth exceeding the second maximum bandwidth, from operation in accordance with the second communication configuration to operation in accordance with the first communication configuration. In some examples, the communication manager 935 is capable of, configured to, or operable to support a means for performing, based on the second transition, the second communication in accordance with the first communication configuration.

In some examples, the communication scheduling manager 930 is capable of, configured to, or operable to support a means for receiving, after reception of the control message, a second control message that includes second scheduling information for a second communication, where the second scheduling information indicates at least one of a rank that exceeds the second maximum rank or a bandwidth that exceeds the second maximum bandwidth. In some examples, the communication manager 935 is capable of, configured to, or operable to support a means for refraining from performing the second communication based on the rank exceeding the second maximum rank or the bandwidth exceeding the second maximum bandwidth and based on operating in accordance with the second communication configuration.

In some examples, the feedback manager 960 is capable of, configured to, or operable to support a means for transmitting a feedback message that indicates that the UE refrained from performance of the second communication.

In some examples, the transition timer manager 950 is capable of, configured to, or operable to support a means for initiating, based on reception of the control message, a timer. In some examples, the communication configuration transition manager 940 is capable of, configured to, or operable to support a means for performing a second transition, based on expiration of the timer, from operation in accordance with the second communication configuration to operation in accordance with the first communication configuration. In some examples, the communication manager 935 is capable of, configured to, or operable to support a means for performing, based on the second transition, a second communication in accordance with the first communication configuration.

In some examples, the communication scheduling manager 930 is capable of, configured to, or operable to support a means for receiving second scheduling information that schedules a set of periodic or semi-persistent scheduled communications associated with the first communication configuration. In some examples, the communication manager 935 is capable of, configured to, or operable to support a means for performing one or more periodic or semi-persistent scheduled communications of the set of periodic or semi-persistent scheduled communications in accordance with the first communication configuration after the transition and while operating in accordance with the second communication configuration.

In some examples, the communication manager 935 is capable of, configured to, or operable to support a means for refraining from performing a periodic or semi-persistent scheduled communication of the set of periodic or semi-persistent scheduled communications based on the periodic or semi-persistent scheduled communication being scheduled in a same slot as the communication.

In some examples, the reference signal manager 955 is capable of, configured to, or operable to support a means for receiving, after the transition and while operating in accordance with the second communication configuration, one or more first CSI-RSs associated with the second communication configuration.

In some examples, the reference signal manager 955 is capable of, configured to, or operable to support a means for refraining from monitoring, after the transition and while operating in accordance with the second communication configuration, one or more second CSI-RSs associated with the first communication configuration.

In some examples, the communication manager 935 is capable of, configured to, or operable to support a means for receiving, after the transition and while operating in accordance with the second communication configuration, a broadcast communication in accordance with the second communication configuration.

In some examples, the communication manager 935 is capable of, configured to, or operable to support a means for receiving, after the transition and while operating in accordance with the second communication configuration, a broadcast communication in accordance with the first communication configuration, where the broadcast communication is received in a different slot than the communication.

In some examples, to support performing the communication, the communication manager 935 is capable of, configured to, or operable to support a means for performing the communication in accordance with the first communication configuration based on the scheduling offset being greater than or equal to the scheduling offset threshold.

In some examples, to support performing the communication, the communication manager 935 is capable of, configured to, or operable to support a means for performing the communication in accordance with the first communication configuration based on the scheduling offset being less than the scheduling offset threshold.

In some examples, the control information indicates the scheduling offset threshold.

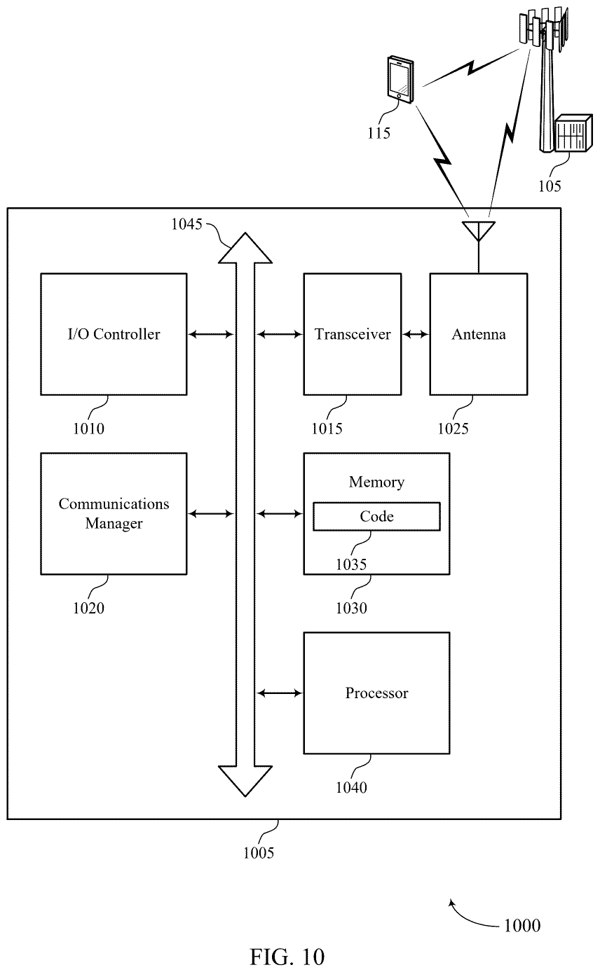

FIG. 10 shows a diagram of a system 1000 including a device 1005 that supports communication configuration adaptation in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting communication configuration adaptation). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving control information that indicates a first communication configuration and a second communication configuration, where the first communication configuration is associated with at least one of a first maximum bandwidth, a first minimum processing timeline, a first minimum scheduling offset, or a first maximum rank, where the second communication configuration is associated with at least one of a second maximum bandwidth, a second minimum processing timeline, a second minimum scheduling offset, or a second maximum rank, and where one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank. The communications manager 1020 is capable of, configured to, or operable to support a means for receiving a control message that includes scheduling information for a communication, where the scheduling information indicates a scheduling offset associated with the communication. The communications manager 1020 is capable of, configured to, or operable to support a means for performing the communication in accordance with one of the first communication configuration or the second communication configuration based on comparison of the scheduling offset to a scheduling offset threshold associated with the second communication configuration.

By including or configuring the communications manager 1020 in accordance with examples as described herein, the device 1005 may support techniques for reduced latency, improved user experience related to reduced processing, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of communication configuration adaptation as described herein, or the at least one processor 1040 and the at least one memory 1030 may be otherwise configured to, individually or collectively, perform or support such operations.

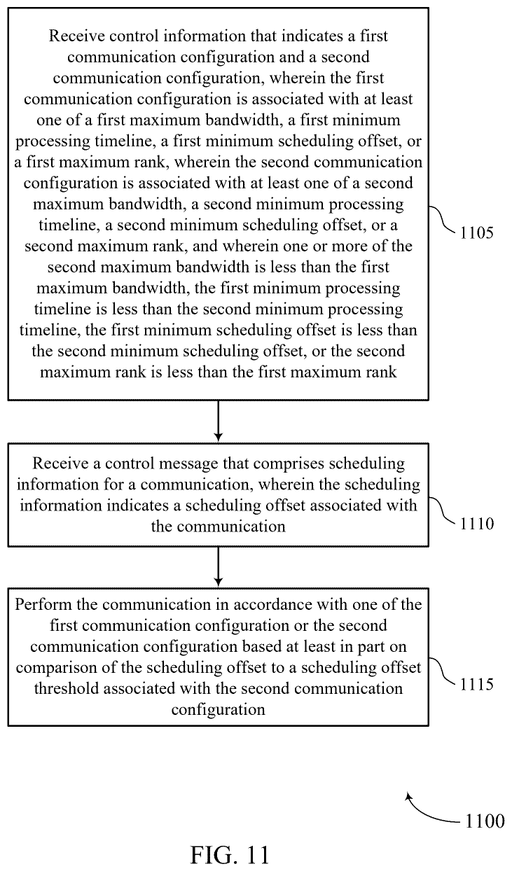

FIG. 11 shows a flowchart illustrating a method 1100 that supports communication configuration adaptation in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving control information that indicates a first communication configuration and a second communication configuration, wherein the first communication configuration is associated with at least one of a first maximum bandwidth, a first minimum processing timeline, a first minimum scheduling offset, or a first maximum rank, wherein the second communication configuration is associated with at least one of a second maximum bandwidth, a second minimum processing timeline, a second minimum scheduling offset, or a second maximum rank, and wherein one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank. The operations of 1105 may be performed in accordance with examples as disclosed herein. In some examples, aspects of the operations of 1105 may be performed by a communication configuration manager 925 as described with reference to FIG. 9.

At 1110, the method may include receiving a control message that comprises scheduling information for a communication, wherein the scheduling information indicates a scheduling offset associated with the communication. The operations of 1110 may be performed in accordance with examples as disclosed herein. In some examples, aspects of the operations of 1110 may be performed by a communication scheduling manager 930 as described with reference to FIG. 9.

At 1115, the method may include performing the communication in accordance with one of the first communication configuration or the second communication configuration based at least in part on comparison of the scheduling offset to a scheduling offset threshold associated with the second communication configuration. The operations of 1115 may be performed in accordance with examples as disclosed herein. In some examples, aspects of the operations of 1115 may be performed by a communication manager 935 as described with reference to FIG. 9.

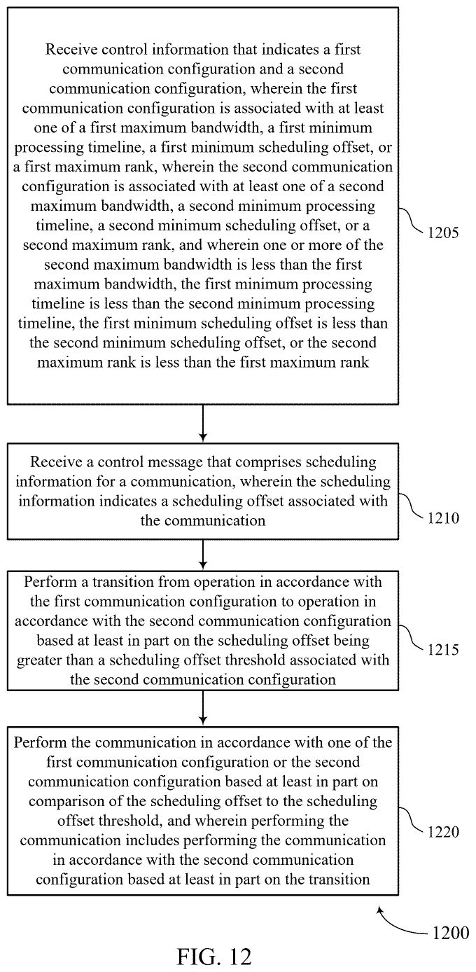

FIG. 12 shows a flowchart illustrating a method 1200 that supports communication configuration adaptation in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving control information that indicates a first communication configuration and a second communication configuration, wherein the first communication configuration is associated with at least one of a first maximum bandwidth, a first minimum processing timeline, a first minimum scheduling offset, or a first maximum rank, wherein the second communication configuration is associated with at least one of a second maximum bandwidth, a second minimum processing timeline, a second minimum scheduling offset, or a second maximum rank, and wherein one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank. The operations of 1205 may be performed in accordance with examples as disclosed herein. In some examples, aspects of the operations of 1205 may be performed by a communication configuration manager 925 as described with reference to FIG. 9.

At 1210, the method may include receiving a control message that comprises scheduling information for a communication, wherein the scheduling information indicates a scheduling offset associated with the communication. The operations of 1210 may be performed in accordance with examples as disclosed herein. In some examples, aspects of the operations of 1210 may be performed by a communication scheduling manager 930 as described with reference to FIG. 9.

At 1215, the method may include performing a transition from operation in accordance with the first communication configuration to operation in accordance with the second communication configuration based at least in part on the scheduling offset being greater than a scheduling offset threshold associated with the second communication configuration. The operations of 1215 may be performed in accordance with examples as disclosed herein. In some examples, aspects of the operations of 1215 may be performed by a communication configuration transition manager 940 as described with reference to FIG. 9.

At 1220, the method may include performing the communication in accordance with one of the first communication configuration or the second communication configuration based at least in part on comparison of the scheduling offset to the scheduling offset threshold, and wherein performing the communication includes performing the communication in accordance with the second communication configuration based at least in part on the transition. The operations of 1220 may be performed in accordance with examples as disclosed herein. In some examples, aspects of the operations of 1220 may be performed by a communication manager 935 as described with reference to FIG. 9.

The following provides an overview of aspects of the present disclosure:

Aspect 1: A method for wireless communications at a UE, comprising: receiving control information that indicates a first communication configuration and a second communication configuration, wherein the first communication configuration is associated with at least one of a first maximum bandwidth, a first minimum processing timeline, a first minimum scheduling offset, or a first maximum rank, wherein the second communication configuration is associated with at least one of a second maximum bandwidth, a second minimum processing timeline, a second minimum scheduling offset, or a second maximum rank, and wherein one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank; receiving a control message that comprises scheduling information for a communication, wherein the scheduling information indicates a scheduling offset associated with the communication; and performing the communication in accordance with one of the first communication configuration or the second communication configuration based at least in part on comparison of the scheduling offset to a scheduling offset threshold associated with the second communication configuration.

Aspect 2: The method of aspect 1, further comprising: performing a transition from operation in accordance with the first communication configuration to operation in accordance with the second communication configuration based at least in part on the scheduling offset being greater than the scheduling offset threshold, and wherein performing the communication comprises performing the communication in accordance with the second communication configuration based at least in part on the transition.

Aspect 3: The method of aspect 2, further comprising: monitoring, after the transition and while operating in accordance with the second communication configuration, one or more first PDCCH candidates associated with the second communication configuration; and refraining from monitoring, after the transition and while operating in accordance with the second communication configuration, one or more second PDCCH candidates associated with the first communication configuration.

Aspect 4: The method of any of aspects 2 through 3, wherein the control message comprises a field that has a value that indicates to operate in accordance with the second communication configuration, and the transition is based at least in part on the field.

Aspect 5: The method of aspect 4, further comprising: receiving a second control message that comprises the field, wherein the field has a second value that indicates to operate in accordance with the first communication configuration; performing a second transition from operation in accordance with the first communication configuration to operation in accordance with the second communication configuration based at least in part on the second control message; and performing, after the second transition, a second communication in accordance with the first communication configuration.

Aspect 6: The method of any of aspects 2 through 5, further comprising: receiving, after reception of the control message, a second control message that comprises second scheduling information for a second communication, wherein the second scheduling information indicates a second scheduling offset associated with the communication; performing a second transition, based at least in part on the second scheduling offset being greater than or equal to the scheduling offset threshold, from operation in accordance with the second communication configuration to operation in accordance with the first communication configuration; and performing, based at least in part on the second transition, the second communication in accordance with the first communication configuration.

Aspect 7: The method of any of aspects 2 through 6, further comprising: receiving, after reception of the control message, a second control message that comprises second scheduling information for a second communication, wherein the second scheduling information indicates a second scheduling offset associated with the communication; and refraining from performing the second communication based at least in part on the second scheduling offset being less than the scheduling offset threshold and based at least in part on operating in accordance with the second communication configuration.

Aspect 8: The method of aspect 7, further comprising: transmitting a feedback message that indicates that the UE refrained from performance of the second communication.

Aspect 9: The method of any of aspects 2 through 8, further comprising: receiving, after reception of the control message, a second control message that comprises second scheduling information for a second communication, wherein the second scheduling information indicates at least one of a rank that exceeds the second maximum rank or a bandwidth that exceeds the second maximum bandwidth; performing a second transition, based at least in part on the rank exceeding the second maximum rank or the bandwidth exceeding the second maximum bandwidth, from operation in accordance with the second communication configuration to operation in accordance with the first communication configuration; and performing, based at least in part on the second transition, the second communication in accordance with the first communication configuration.

Aspect 10: The method of any of aspects 2 through 8, further comprising: receiving, after reception of the control message, a second control message that comprises second scheduling information for a second communication, wherein the second scheduling information indicates at least one of a rank that exceeds the second maximum rank or a bandwidth that exceeds the second maximum bandwidth; and refraining from performing the second communication based at least in part on the rank exceeding the second maximum rank or the bandwidth exceeding the second maximum bandwidth and based at least in part on operating in accordance with the second communication configuration.

Aspect 11: The method of aspect 10, further comprising: transmitting a feedback message that indicates that the UE refrained from performance of the second communication.

Aspect 12: The method of any of aspects 2 through 11, further comprising: initiating, based at least in part on reception of the control message, a timer; performing a second transition, based at least in part on expiration of the timer, from operation in accordance with the second communication configuration to operation in accordance with the first communication configuration; and performing, based at least in part on the second transition, a second communication in accordance with the first communication configuration.

Aspect 13: The method of any of aspects 2 through 12, further comprising: receiving second scheduling information that schedules a set of periodic or semi-persistent scheduled communications associated with the first communication configuration; and performing one or more periodic or semi-persistent scheduled communications of the set of periodic or semi-persistent scheduled communications in accordance with the first communication configuration after the transition and while operating in accordance with the second communication configuration.

Aspect 14: The method of aspect 13, further comprising: refraining from performing a periodic or semi-persistent scheduled communication of the set of periodic or semi-persistent scheduled communications based at least in part on the periodic or semi-persistent scheduled communication being scheduled in a same slot as the communication.

Aspect 15: The method of any of aspects 2 through 14, further comprising: receiving, after the transition and while operating in accordance with the second communication configuration, one or more first CSI-RSs associated with the second communication configuration.

Aspect 16: The method of aspect 15, further comprising: refraining from monitoring, after the transition and while operating in accordance with the second communication configuration, one or more second CSI-RSs associated with the first communication configuration.

Aspect 17: The method of any of aspects 2 through 16, further comprising: receiving, after the transition and while operating in accordance with the second communication configuration, a broadcast communication in accordance with the second communication configuration.

Aspect 18: The method of any of aspects 2 through 17, further comprising: receiving, after the transition and while operating in accordance with the second communication configuration, a broadcast communication in accordance with the first communication configuration, wherein the broadcast communication is received in a different slot than the communication.

Aspect 19: The method of any of aspect 1, wherein performing the communication comprises: performing the communication in accordance with the first communication configuration based at least in part on the scheduling offset being greater than or equal to the scheduling offset threshold.

Aspect 20: The method of any of aspects 1 through 19, wherein the control information indicates the scheduling offset threshold.

Aspect 21: A UE for wireless communications, comprising one or more memories storing processor-executable code, and one or more processors coupled with the one or more memories and individually or collectively operable to execute the code to cause the UE to perform a method of any of aspects 1 through 20.

Aspect 22: A UE for wireless communications, comprising at least one means for performing a method of any of aspects 1 through 20.

Aspect 23: A non-transitory computer-readable medium storing code for wireless communications, the code comprising instructions executable by one or more processors to perform a method of any of aspects 1 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information that indicates a first communication configuration and a second communication configuration, wherein the first communication configuration is associated with at least one of a first maximum bandwidth, a first minimum processing timeline, a first minimum scheduling offset, or a first maximum rank, wherein the second communication configuration is associated with at least one of a second maximum bandwidth, a second minimum processing timeline, a second minimum scheduling offset, or a second maximum rank, and wherein one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank;
receive a control message that comprises scheduling information for a communication, wherein the scheduling information indicates a scheduling offset associated with the communication; and
perform the communication in accordance with one of the first communication configuration or the second communication configuration based at least in part on comparison of the scheduling offset to a scheduling offset threshold associated with the second communication configuration.

2. The UE of claim 1, wherein the one or more processors are individually or collectively further operable to execute the code to cause the UE to:
perform a transition from operation in accordance with the first communication configuration to operation in accordance with the second communication configuration based at least in part on the scheduling offset being greater than the scheduling offset threshold, and wherein performing the communication comprises performing the communication in accordance with the second communication configuration based at least in part on the transition.

3. The UE of claim 2, wherein the one or more processors are individually or collectively further operable to execute the code to cause the UE to:
monitor, after the transition and while operating in accordance with the second communication configuration, one or more first physical downlink control channel candidates associated with the second communication configuration; and
refrain from monitoring, after the transition and while operating in accordance with the second communication configuration, one or more second physical downlink control channel candidates associated with the first communication configuration.

4. The UE of claim 2, wherein:
the control message comprises a field that has a value that indicates to operate in accordance with the second communication configuration, and
the transition is based at least in part on the field.

5. The UE of claim 4, wherein the one or more processors are individually or collectively further operable to execute the code to cause the UE to:
receive a second control message that comprises the field, wherein the field has a second value that indicates to operate in accordance with the first communication configuration;
perform a second transition from operation in accordance with the first communication configuration to operation in accordance with the second communication configuration based at least in part on the second control message; and
perform, after the second transition, a second communication in accordance with the first communication configuration.

6. The UE of claim 2, wherein the one or more processors are individually or collectively further operable to execute the code to cause the UE to:
receive, after reception of the control message, a second control message that comprises second scheduling information for a second communication, wherein the second scheduling information indicates a second scheduling offset associated with the communication;
perform a second transition, based at least in part on the second scheduling offset being greater than or equal to the scheduling offset threshold, from operation in accordance with the second communication configuration to operation in accordance with the first communication configuration; and
perform, based at least in part on the second transition, the second communication in accordance with the first communication configuration.

7. The UE of claim 2, wherein the one or more processors are individually or collectively further operable to execute the code to cause the UE to:
receive, after reception of the control message, a second control message that comprises second scheduling information for a second communication, wherein the second scheduling information indicates a second scheduling offset associated with the communication; and
refrain from performing the second communication based at least in part on the second scheduling offset being less than the scheduling offset threshold and based at least in part on operating in accordance with the second communication configuration.

8. The UE of claim 7, wherein the one or more processors are individually or collectively further operable to execute the code to cause the UE to:
transmit a feedback message that indicates that the UE refrained from performance of the second communication.

9. The UE of claim 2, wherein the one or more processors are individually or collectively further operable to execute the code to cause the UE to:
receive, after reception of the control message, a second control message that comprises second scheduling information for a second communication, wherein the second scheduling information indicates at least one of a rank that exceeds the second maximum rank or a bandwidth that exceeds the second maximum bandwidth;
perform a second transition, based at least in part on the rank exceeding the second maximum rank or the bandwidth exceeding the second maximum bandwidth, from operation in accordance with the second communication configuration to operation in accordance with the first communication configuration; and
perform, based at least in part on the second transition, the second communication in accordance with the first communication configuration.

10. The UE of claim 2, wherein the one or more processors are individually or collectively further operable to execute the code to cause the UE to:
receive, after reception of the control message, a second control message that comprises second scheduling information for a second communication, wherein the second scheduling information indicates at least one of a rank that exceeds the second maximum rank or a bandwidth that exceeds the second maximum bandwidth; and
refrain from performing the second communication based at least in part on the rank exceeding the second maximum rank or the bandwidth exceeding the second maximum bandwidth and based at least in part on operating in accordance with the second communication configuration.

11. The UE of claim 2, wherein the one or more processors are individually or collectively further operable to execute the code to cause the UE to:
initiate, based at least in part on reception of the control message, a timer;
perform a second transition, based at least in part on expiration of the timer, from operation in accordance with the second communication configuration to operation in accordance with the first communication configuration; and
perform, based at least in part on the second transition, a second communication in accordance with the first communication configuration.

12. The UE of claim 2, wherein the one or more processors are individually or collectively further operable to execute the code to cause the UE to:
receive second scheduling information that schedules a set of periodic or semi-persistent scheduled communications associated with the first communication configuration; and
perform one or more periodic or semi-persistent scheduled communications of the set of periodic or semi-persistent scheduled communications in accordance with the first communication configuration after the transition and while operating in accordance with the second communication configuration.

13. The UE of claim 12, wherein the one or more processors are individually or collectively further operable to execute the code to cause the UE to:
refrain from performing a periodic or semi-persistent scheduled communication of the set of periodic or semi-persistent scheduled communications based at least in part on the periodic or semi-persistent scheduled communication being scheduled in a same slot as the communication.

14. The UE of claim 2, wherein the one or more processors are individually or collectively further operable to execute the code to cause the UE to:
receive, after the transition and while operating in accordance with the second communication configuration, one or more first channel state information reference signals associated with the second communication configuration.

15. The UE of claim 14, wherein the one or more processors are individually or collectively further operable to execute the code to cause the UE to:
refrain from monitoring, after the transition and while operating in accordance with the second communication configuration, one or more second channel state information reference signals associated with the first communication configuration.

16. The UE of claim 2, wherein the one or more processors are individually or collectively further operable to execute the code to cause the UE to:
receive, after the transition and while operating in accordance with the second communication configuration, a broadcast communication in accordance with the second communication configuration.

17. The UE of claim 2, wherein the one or more processors are individually or collectively further operable to execute the code to cause the UE to:
receive, after the transition and while operating in accordance with the second communication configuration, a broadcast communication in accordance with the first communication configuration, wherein the broadcast communication is received in a different slot than the communication.

18. The UE of claim 1, wherein, to perform the communication, the one or more processors are individually or collectively operable to execute the code to cause the UE to:
perform the communication in accordance with the first communication configuration based at least in part on the scheduling offset being greater than or equal to the scheduling offset threshold.

19. A method for wireless communications at a user equipment (UE), comprising:
receiving control information that indicates a first communication configuration and a second communication configuration, wherein the first communication configuration is associated with at least one of a first maximum bandwidth, a first minimum processing timeline, a first minimum scheduling offset, or a first maximum rank, wherein the second communication configuration is associated with at least one of a second maximum bandwidth, a second minimum processing timeline, a second minimum scheduling offset, or a second maximum rank, and wherein one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank;
receiving a control message that comprises scheduling information for a communication, wherein the scheduling information indicates a scheduling offset associated with the communication; and
performing the communication in accordance with one of the first communication configuration or the second communication configuration based at least in part on comparison of the scheduling offset to a scheduling offset threshold associated with the second communication configuration.

20. A non-transitory computer-readable medium storing code for wireless communications, the code comprising instructions executable by one or more processors to:
receive control information that indicates a first communication configuration and a second communication configuration, wherein the first communication configuration is associated with at least one of a first maximum bandwidth, a first minimum processing timeline, a first minimum scheduling offset, or a first maximum rank, wherein the second communication configuration is associated with at least one of a second maximum bandwidth, a second minimum processing timeline, a second minimum scheduling offset, or a second maximum rank, and wherein one or more of the second maximum bandwidth is less than the first maximum bandwidth, the first minimum processing timeline is less than the second minimum processing timeline, the first minimum scheduling offset is less than the second minimum scheduling offset, or the second maximum rank is less than the first maximum rank;
receive a control message that comprises scheduling information for a communication, wherein the scheduling information indicates a scheduling offset associated with the communication; and
perform the communication in accordance with one of the first communication configuration or the second communication configuration based at least in part on comparison of the scheduling offset to a scheduling offset threshold associated with the second communication configuration.
